(19) United States
(12) Patent Application Publication
(10) Pub. No.: US 2010/0038568 A1
(43) Pub. Date: Feb. 18, 2010

(54) ELECTROMOTIVE REFRIGERANT CONTROL VALVE

(76) Inventor: Hoon-Il Kang, Gyeonggi-do (KR)

Correspondence Address: IPLA P.A., 3550 WILSHIRE BLVD., 17TH FLOOR, LOS ANGELES, CA, 90010, US

(21) Appl. No.: 11/816,121

(22) PCT Filed: Nov. 21, 2005
(86) PCT No.: PCT/KR05/03928

§ 371 Date: Aug. 13, 2007

(30) Foreign Application Priority Data
Nov. 22, 2004 (KR) 10-2004-0095664

(51) Int. Cl. F16K 31/08

(52) U.S. Cl. 251/65

(57) ABSTRACT

An electromotive refrigerant control valve is disclosed, in which the refrigerant supplied from the condenser is supplied to the evaporator for the cooling chamber or the evaporator for the freezing chamber based on the four operation modes. The four operation modes are a cooling/freezing mode in which the refrigerant is concurrently supplied to the cooling chamber evaporator and the freezing chamber evaporator, a cooling mode in which the refrigerant is supplied to only the cooling chamber evaporator, and the refrigerant is not supplied to the freezing chamber evaporator, an idle mode in which the refrigerant is not concurrently supplied to the cooling chamber evaporator and the freezing chamber evaporator, and a freezing mode in which the refrigerant is supplied to only the freezing chamber evaporator, and the refrigerant is not supplied to the cooling chamber evaporator.

### TECHNICAL FIELD

The present invention relates to a refrigerant control valve for a cooling chamber or a freezing chamber, and in particular to an electromotive refrigerant control valve.

### BACKGROUND ART

Generally, a cooling chamber or a freezing chamber has a refrigerant circulation line of a compressor->a condenser->an evaporator->a compressor. In case that a cooling chamber and freezing chamber are partitioned by a partition wall, an evaporator is separately installed in the cooling chamber and the freezing chamber so as to cool the air in the cooling and freezing chambers.

In the case that the evaporator is separately installed in the cooling chamber and the freezing chamber, refrigerant is supplied to the evaporator of the cooling chamber and the evaporator of the freezing chamber using an electromotive refrigerant control valve.

As shown in FIG. 1, a conventional electromotive refrigerant control valve 100 includes a shaft part 11 extended from a lower side of a hollow body 10. A rotor 30 is provided in the interior of the body 10, with a male thread part 32 being formed at a front end of a shaft 31, and with the rotor being supported downward by a spring in the direction of the body 10. A stator assembly 40 is attached to an outer surface of the body 10 so as to generate a magnetic force for thereby rotating the rotor 30.

As shown in FIG. 1, the shaft part 11 extended from the lower side of the hollow body 10 includes a shaft guide groove 12 in which the shaft 31 of the rotor 30 reciprocates, with the shaft guide groove being formed at the interior of the upper side of the same. A female thread part 13 engaged with the male thread part 32 of the shaft 31 is formed at a front inner surface of the shaft guide groove 12. A spring mount 51 is provided in the interior of the shaft guide groove 12. A part of a rod shaped moving member 50, in which a spherical valve assembly 52 is formed at a lower end, is provided. A coil spring 60 is disposed between the male thread part 32 of the shaft 31 and the spring mount 51.

As shown in FIG. 1, the shaft part 11 includes a refrigerant inlet A, a first refrigerant outlet B, and a second refrigerant outlet C formed at the right surface, lower surface and left surface, with a pipe passing through the inlet A and the outlets B and C. A flow path 14 communicating with the refrigerant inlet A, and the first and second refrigerant outlets B and C is formed at the interior of the lower side.

The refrigerant inlet A formed at the shaft part 11 is connected with the condenser (not shown) through the pipe, and the first refrigerant outlet B is connected with the evaporator (not shown) for the cooling chamber through the pipe, and the second refrigerant outlet C is connected with the evaporator (not shown) for the freezing chamber through the pipe.

The flow path 14 forms a partition wall together with the shaft guide groove 12, and a part of the rod shaped moving member 50 and the spherical valve assembly 52 are received in the interior of the flow path 14 through the partition wall.

A first valve seat 15 and a second valve seat 16 are provided in the interior of the flow path 14. Here, the first valve seat 15 limits the movement when the spherical valve assembly 52 of the moving member 50 moves downwards with respect to the axial direction of the shaft part 11 in cooperation with the shaft 31 of the rotor 30 and closes the first refrigerant outlet B. The second valve seat 16 limits the movements when the spherical valve assembly 52 of the moving member 50 moves upwards with respect to the axial direction of the shaft part 11 and closes the second refrigerant outlet C.

The operation of the conventional electromotive refrigerant control valve 100 will be described.

As shown in FIG. 1, the rotor 30 and the stator assembly 40 form the motor. In the electromotive actuator, the flow path 14 of the valve is switched by reciprocating the spherical valve assembly 52 in the axial direction of the shaft part 11.

As the shaft 31 of the rotor 30 rotates in the normal direction and pushes the rod shaped moving member 50 in the axial direction of the shaft part 11, the spherical valve assembly 52 of the moving member 50 moves toward the lower most portion of the flow path 14 and contacts with the first valve seat 15, so that the first refrigerant outlet B is closed, and the second refrigerant outlet C is opened. Therefore, the refrigerant inputted through the refrigerant inlet A is supplied to the evaporator (not shown) for the freezing chamber through the pipe of the second refrigerant outlet C.

On the contrary, as the shaft 31 of the rotor 30 rotates in the reverse direction and moves the rod shaped moving member 50 in the upward axial direction of the shaft part 11, the spherical valve assembly 52 of the moving member 50 moves in the upper most direction of the flow path 14 and contacts with the second valve seat 16. Since the first refrigerant outlet B is opened, and the second refrigerant outlet C is closed, the refrigerant inputted through the refrigerant inlet A is supplied to the evaporator (not shown) for the cooling chamber through the pipe of the first refrigerant outlet B.

However, the conventional electromotive refrigerant control valve 100 has only two refrigerant supply paths communicating with the flow path 14. Since the evaporator for the cooling chamber or the evaporator for the freezing chamber should be always operated by switching the paths for supplying refrigerant to the evaporator for the cooling chamber and for supplying refrigerant to the evaporator for the freezing chamber. Therefore, the interiors of the evaporator for the cooling chamber and the freezing chamber for the freezing chamber are designed to be continuously cooled though an enough freezing or cooling condition is met in the interiors of the same. The freezing or cooling efficiency decreases, and the energy consumption increases.

### DISCLOSURE OF INVENTION

Accordingly, it is an object of the present invention to overcome the problems encountered in the conventional art.

It is another object of the present invention to provide an electromotive refrigerant control valve in which the refrigerant supplied from the condenser is supplied to the evaporator for the cooling chamber or the evaporator for the freezing chamber based on the four operation modes. The four operation modes are a cooling/freezing mode in which the refrigerant is concurrently supplied to the cooling chamber evaporator and the freezing chamber evaporator, a cooling mode in which the refrigerant is supplied to only the cooling chamber evaporator, and the refrigerant is not supplied to the freezing chamber evaporator, an idle mode in which the refrigerant is not concurrently supplied to the cooling chamber evaporator and the freezing chamber evaporator, and a freezing mode in which the refrigerant is supplied to only the freezing chamber evaporator, and the refrigerant is not supplied to the cooling chamber evaporator.

### TECHNICAL SOLUTIONS

To achieve the above objects, there is provided an electromotive refrigerant control valve which comprises a cap shaped rotor casing in which a shaft rest part is formed at an upper surface of the same; a magnet which is fixedly inserted into the interior of the rotor casing, with a shaft being fixedly inserted into a hub formed at a center portion of the magnet, with one end of the shaft being inserted into the shaft rest part, and with a valve assembly fixture being formed at one side of the lower inner surface with respect to the center portion, and with a protrusion being formed at one side of the lower surface of the magnet; a stator assembly which is attached to an outer surface of the rotor casing and generates a magnetic force so as to rotate the magnet; a compression spring which is inserted into the lower end of the hub of the magnet; a valve assembly in which a through hole is formed at a center portion of the valve assembly, with the shaft being fixedly inserted into the through hole, and with a fixing part, which is inserted into the valve assembly fixture of the magnet, being formed at an outer surface of one side with respect to the through hole, and with a refrigerant path groove being formed at an outer surface of the other side, and with the valve assembly being designed to rotate together with the magnet by a rotational force of the magnet which is transferred through the valve assembly fixture of the magnet and the fixing part based on a repulsive force of the compression spring as the upper surface of the valve assembly contacts with the compression spring; a base plate in which a through hole is formed at a center portion of the base plate, with an end portion of the shaft, fixedly inserted into the valve assembly, being inserted into the through hole, and with a first refrigerant outlet guide hole and a second refrigerant outlet guide hole being formed at regular intervals with respect to the through hole, and with a refrigerant inlet path part, a stopper groove and a cover fixing groove being formed at an outer surface of the base plate at regular intervals; an under cover which covers a lower opening of the rotor casing, with a through hole being formed at a center portion of the under cover, with an end portion of the shaft, passed through the base plate, being inserted into the through hole, and with a first refrigerant outlet hole, a second refrigerant outlet hole and a refrigerant inlet guide hole, which communicate with the first refrigerant outlet hole, the second refrigerant outlet guide hole and the refrigerant inlet path part of the base plate, being formed at regular intervals with respect to the through hole, and with a stopper and a fixing protrusion being protruded from the upper surface of the under cover and being fixed with the stopper groove and the cover fixing groove of the base plate, respectively, and with a plurality of cover fixing protrusions being protruded from the lower surface of the under cover; and a valve housing in which a plurality of fixing protrusion grooves engaged with the cover fixing protrusions of the under cover are formed on an upper surface contacting with an end portion of the shaft which passed through the under cover, and a refrigerant inlet communicates with the refrigerant inlet path part of the base plate, and a first refrigerant outlet and a second refrigerant outlet communicate with the first refrigerant outlet hole and the second refrigerant outlet hole of the under cover.

To achieve the above objects, there is provided an electromotive refrigerant control valve which comprises a cap shaped rotor casing in which a shaft rest part is formed at an upper surface of the same; a magnet which is fixedly inserted into the interior of the rotor casing, with a shaft being fixedly inserted into a hub formed at a center portion of the magnet, with an end portion of one side being inserted into the shaft rest part, and with a protrusion being protruded from one side of a lower surface with respect to the center portion, and with a valve assembly fixture being formed at the protrusion; a stator assembly which is attached to an outer surface of the rotor casing and generates a magnetic force so as to rotate the magnet; a compression spring which is inserted into a lower end of the hub of the magnet; a valve assembly in which a through hole is formed at a center portion of the valve assembly, with the shaft being inserted into the through hole, and a spring groove is formed around the through hole of the upper surface, with one end of the compression spring being inserted into the spring groove, and a refrigerant path groove is formed at an outer surface of one side with respect to the through hole, and a pair of fixing protrusions inserted into the valve assembly fixtures of the magnet are formed with respect to the refrigerant path groove of the outer surface of the one side, with the valve assembly being rotated together with the magnet by a rotational force of the magnet transferred through the valve assembly fixture of the magnet and the fixing protrusion based on a repulsive force of the compression spring fixed at the upper surface of the same; a base plate in which a through hole is formed at a center portion of the base plate, with an end portion of the shaft, inserted into the valve assembly, being inserted into the through hole, and a first refrigerant outlet guide groove and a second refrigerant outlet guide groove are formed at a lower surface of the base plate at regular intervals with respect to the through hole, and a guide hole communicating with the upper surface is formed at both ends of the first refrigerant outlet guide hole and the second refrigerant outlet guide groove, and a first cover fixing groove and a second cover fixing groove are formed with regular intervals which are larger than the intervals of the first refrigerant outlet guide groove and the second refrigerant outlet guide groove with respect to the through hole, and a refrigerant inlet path part is formed at an outer surface of the base plate and is straight with respect to the first cover fixing groove; a under cover which covers a lower opening of the rotor casing, and in which a through hole being is formed at a center portion, with an end portion of the shaft, passed through the base plate, being inserted into the through hole, and a first refrigerant outlet hole and a second refrigerant outlet hole communicating with the first refrigerant outlet guide groove and the second refrigerant outlet guide groove of the base plate are formed with regular intervals with respect to the through hole, and a first fixing protrusion and a second fixing protrusion engaged with the first cover fixing groove and second cover fixing groove of the base plate are protruded from the upper surface of the under cover, and a valve housing receiving part is formed at a lower surface of the under cover, and a stopper shaft passes through the upper and lower surfaces and are caught by one side of each of the fixing protrusions of the rotating valve assembly; and a valve housing which is fixedly inserted into the valve housing receiving part of the under cover, and in which a stopper groove is formed at an upper surface contacting with an end portion of the shaft which passed through the under cover, with one end of the stopper shaft, protruded from the lower surface of the under cover, being inserted into the stopper groove, and a refrigerant inlet communicates with the refrigerant inlet path part of the base plate, and a first refrigerant outlet and a second refrigerant outlet communicate with the first refrigerant outlet hole and the second refrigerant outlet hole of the under cover, respectively.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a conventional electromotive refrigerant control valve;

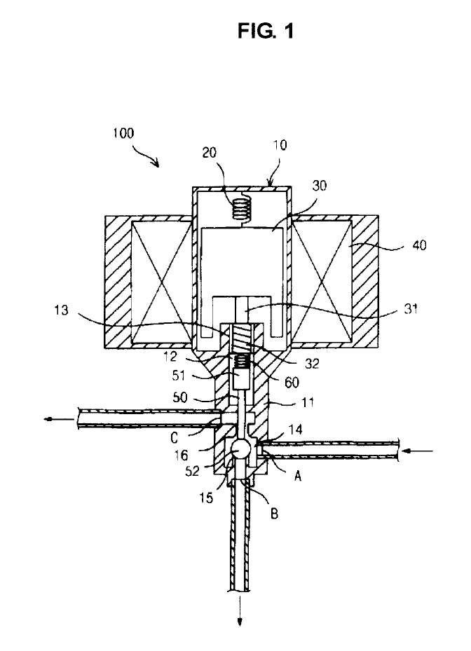

FIG. 2 is a cross sectional view illustrating an electromotive refrigerant control valve according to a first embodiment of the present invention;

FIG. 3 is a disassembled perspective view of the construction of the present invention except for a stator assembly of FIG. 2;

FIG. 4 is a perspective view illustrating a valve assembly of FIG. 2;

FIG. 5 is a plane view illustrating a base plate of FIG. 2;

FIG. 6 is a perspective view illustrating an under cover of FIG. 2;

FIG. 7 is a lateral view of FIG. 6;

FIG. 8 is a plane view illustrating a valve housing of FIG. 2;

FIG. 9 is a view of an operation mode of an electromotive refrigerant control valve according to a first embodiment of the present invention;

FIG. 10 is a view of another operation mode of an electromotive refrigerant control valve according to a first embodiment of the present invention;

FIG. 11 is a cross sectional view illustrating an electromotive refrigerant control valve according to a second embodiment of the present invention;

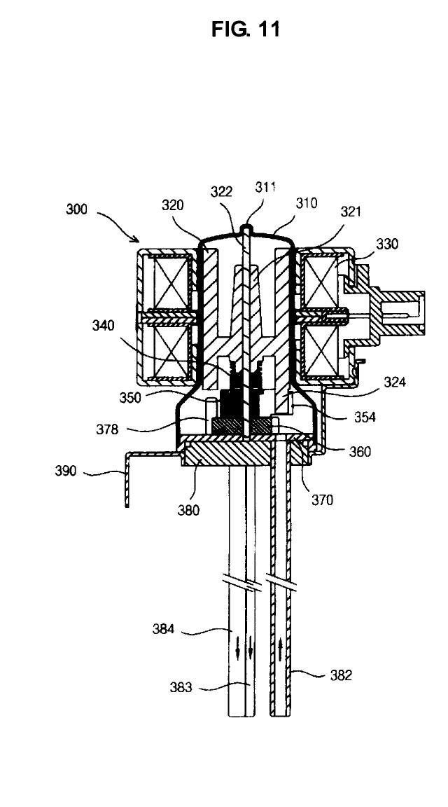

FIG. 12 is a disassembled perspective view illustrating the construction except for the stator assembly of FIG. 11;

FIG. 13 is a perspective view illustrating a valve assembly of FIG. 11;

FIG. 14 is a plane view illustrating a base plate of FIG. 11;

FIG. 15 is a bottom view of FIG. 14;

FIG. 16 is a cross sectional view taken along line A-A′ of FIG. 15;

FIG. 17 is a cross sectional view taken along line B-B′ of FIG. 15;

FIG. 18 is a plane view illustrating a state that an under cover and a stopper shaft of FIG. 11 are engaged;

FIG. 19 is a lateral view of FIG. 18;

FIG. 20 is a cross sectional view taken along line A-A′ of FIG. 18;

FIG. 21 is a plane view illustrating a valve housing of FIG. 11;

FIG. 22 is a cross sectional view taken along line A-A′ of FIG. 21;

FIG. 23 is a cross sectional view taken along line B-B′ of FIG. 21; and

FIG. 24 is a view illustrating an operation mode of an electromotive refrigerant control valve according to a second embodiment of the present invention.

### BEST MODE FOR CARRYING OUT THE INVENTION

The first embodiment of the present invention will be described with reference to the accompanying drawings.

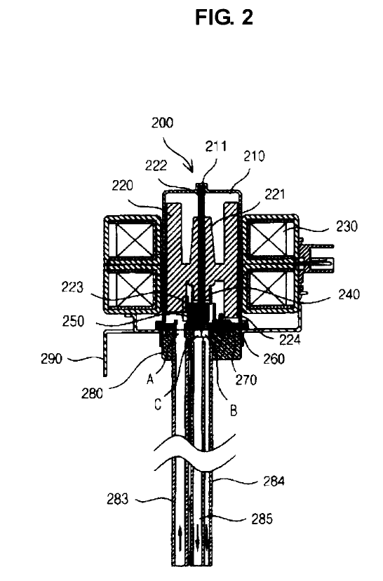

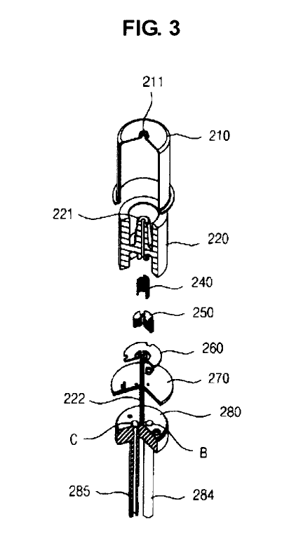

As shown in FIGS. 2 through 8, the rotor casing 210 is formed in a cap shape in which a shaft rest part 211 is formed on the top of the same, with a lower open part being covered by the under cover 270.

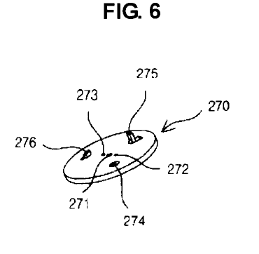

A magnet 220 is fixedly installed in the interior of the rotor casing 210. A shaft 222 is fixedly inserted into a hub 221 formed at the center, with one end of the same being inserted into the shaft rest part 211. In the magnet 220, a valve assembly fixture 223 is formed at one side of the lower inner surface with respect to the center. A protrusion 224 is formed at one side of the lower surface and limits the rotation of the magnet 220 as it is caught by a stopper 275 (FIG. 6) of the under cover 270.

A stator assembly 230 is attached to an outer surface of the rotor casing 210 and generates magnetic force so as to rotate the magnet 220. The stator assembly 230 forms a motor together with the magnet 220 which is provided in the rotor casing 210 and operates as a rotor. The stator assembly 230 operates as an electromotive actuator which rotates the magnet 220 in a normal or reverse direction in accordance with a motor control pulse signal inputted from an external motor driver (not shown) for thereby switching the refrigerant supply path.

The compression spring 240 is inserted into a lower end of the hub 221 of the magnet 220 and generates a certain force which pushes down the valve assembly 250 in the axial direction of the shaft 222.

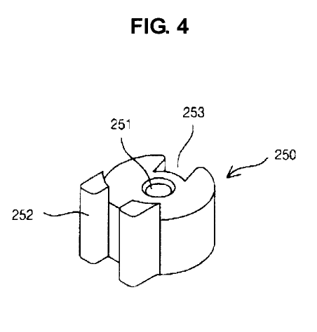

As shown in FIG. 4, the valve assembly 250 includes a through hole 251 formed at the center of the same, with the shaft 222 being inserted into the through hole 251. A fixing part 252 is formed at an outer side surface with respect to the through hole 251 and is inserted into the valve assembly fixture 223 of the magnet 220. A refrigerant path groove 253 is formed at the outer surface of the other side. Here, the valve assembly 250 rotates together with the magnet by the rotational force of the magnet 220 which is received through the valve assembly fixture 223 of the magnet 220 and the fixing part 252 as the upper surface of the valve assembly 250 contacts with the compression spring 240 and receives a repulsive force of the compression spring 240. Since the valve assembly 250 has a plane lower surface, so that it closely contacts with the base plate 260 for thereby preventing refrigerant leakage. Here, the valve assembly 250 is preferably made of ceramic material which has excellent heat-resisting property and durability for thereby preventing thermal transformation and extending life span.

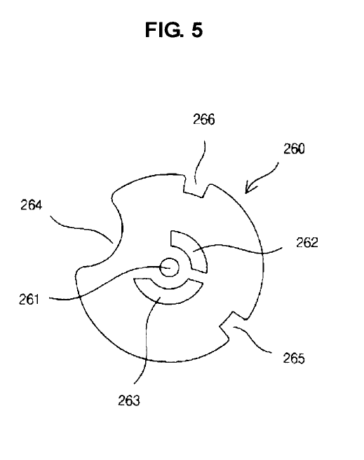

As shown in FIG. 5, the base plate 260 includes a through hole 261 formed at the center portion of the same, with an end portion of the shaft 222 fixedly inserted into the valve assembly 250 being inserted into the through hole 261. A first refrigerant outlet guide hole 262 and a second refrigerant outlet guide hole 263 are formed with regular intervals with respect to the through hole 261. Here, the first refrigerant outlet guide hole 262 and the second refrigerant outlet guide hole 263 are preferably formed in arc shapes. The base plate 260 includes a refrigerant inlet path part 264, a stopper groove 265, and a cover fixing groove 266 which are distanced at certain intervals.

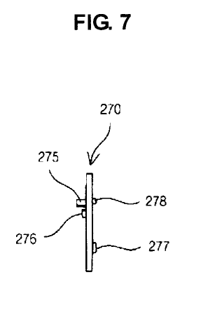

As shown in FIGS. 6 and 7, the under cover 270 covers the lower opening of the rotor casing 210 and forms a refrigerant flow path in the interior of the rotor casing 310. The under cover 270 includes a through hole 271 formed at the center portion, with an end of the shaft 222, which passes through the base plate 260, being inserted into the through hole 271. With certain intervals with respect to the through hole 271, there are provided the first refrigerant outlet hole 272, the second refrigerant outlet hole 273, and the refrigerant inlet guide hole 274 which communicate with the first refrigerant outlet guide hole 262, the second refrigerant outlet guide hole 263 and the refrigerant inlet path part 264 of the base plate 260. The under cover 270 is provided with a stopper 275 and a fixing protrusion 276 which are inserted into the stopper groove 265 and the cover fixing groove 266 of the base plate 260 and is further provided with a plurality of cover fixing protrusions 277 and 278 formed at the lower surface. Therefore, the base plate 260 does not rotate together with the magnet, namely, is fixed.

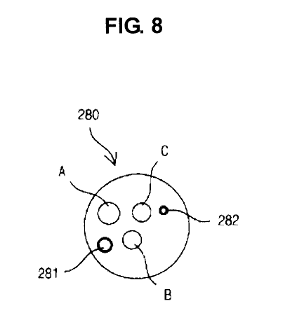

As shown in FIG. 8, the valve housing 280 includes a plurality of fixing protrusion grooves 281 and 282 into which the cover fixing protrusions 277 and 278 of the under cover 270 are inserted at the upper surface in which the end of the shaft, passed through the under cover, contacts. In the valve housing 280, there is provided a refrigerant inlet A which communicates with the refrigerant inlet path part 264 of the base plate 260 through the refrigerant inlet guide hole 274 of the under cover 270 and is connected with the condenser (not shown) by the input pipe 283. In addition, a first refrigerant outlet B communicates with the first refrigerant outlet hole 272 of the under cover 270 and is connected with the cooling chamber evaporator (not shown) by the output pipe 284. A second refrigerant outlet C communicates with the second refrigerant outlet hole 273 of the under cover 270 and is connected with the freezing chamber evaporator (not shown) by the output pipe 285.

The bracket 290 covers the lower opening of the rotor casing 210 and engages the valve housing 280 and the stator assembly 230, with the under cover 270, which forms the refrigerant flow path in the interior of the rotor casing 210 being fixed at the valve housing 280.

The operation of the electromotive refrigerant control valve 200 according to a first embodiment of the present invention will be described with reference to the accompanying drawings.

When power is supplied to the motor which is provided with the stator assembly 230 and the magnet 220 and operates as an electromotive actuator, the magnet 220 is rotated in a normal or reverse direction by the magnetic force generated by the stator assembly 230 and allows the protrusion 224 to be caught by the stopper 275 of the under cover 270, so that the initialization, namely, zero setting, is finished.

In the electromotive refrigerant control valve 200 according to the present invention, the rotational force of the magnet 220 is transferred to the valve assembly fixture 223 of the magnet 220 and the fixing part 252 of the valve assembly 250 and allows the valve assembly 250 to rotate in a normal direction or reverse direction. With the above operation, there is formed a refrigerant supply path of the refrigerant inlet A of the valve housing 280->the refrigerant inlet guide hole 274 of the under cover 270->the refrigerant inlet path part 264 of the base plate 260->the refrigerant flow path formed in the interior of the rotor casing 210->the refrigerant path groove 253 of the valve assembly 250->the first refrigerant outlet guide hole 262 or the second refrigerant outlet guide hole 263 of the base plate 260->the first refrigerant outlet hole 272 or the second refrigerant outlet hole 273 of the under cover 270->the first refrigerant outlet B or the second refrigerant outlet C of the valve housing 280->the output pipe 284 or the output pipe 285->the cooling chamber evaporator (not shown) or the freezing chamber evaporator (not shown).

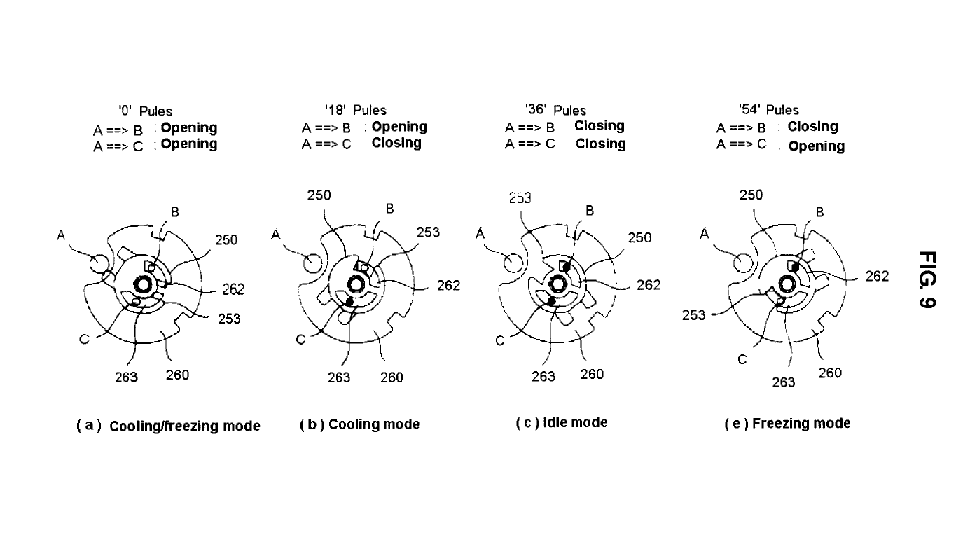

As shown in FIG. 9, so as to operate in the cooling/freezing mode, it is needed to set the zero setting (initialization position). When a motor control pulse signal (for example “0” pulse) is inputted into the motor (the valve assembly 250 rotates, but the base plate 260 does not rotate), as shown in FIG. 9A, the refrigerant path groove 253 of the valve assembly 250 is positioned to communicate with part of the first refrigerant outlet guide hole 262 of the base plate 260 and part of the second refrigerant guide hole 263, and the refrigerant is supplied to the cooling chamber evaporator and the freezing chamber evaporator through the first refrigerant outlet B and the second refrigerant outlet C of the valve housing 280. In this case, the system operates in the cooling/freezing mode.

For the operation in the cooling mode, it is needed to set the zero position (initialization position). When a motor control pulse signal (for example, “18” pulse) is inputted for operating in the cooling mode, the refrigerant path groove 253 of the valve assembly 250 communicates with the first refrigerant outlet guide hole 262 of the base plate 260, but does not communicates with the second refrigerant outlet guide hole 263. The refrigerant is supplied to only the cooling chamber evaporator through the first refrigerant outlet B of the valve housing 280. Here, the system operates in the cooling mode.

For the operation in the idle mode, it is needed to set the zero position (initialization position). When a motor control pulse signal (for example, “36” pulse) is inputted into the motor, as shown in FIG. 9C, the refrigerant path groove 253 of the valve assembly 250 does not communicate with both the first refrigerant outlet guide hole 262 and the second refrigerant outlet guide hole 263 of the base plate 260. When supplying the refrigerant, the refrigerant does not flow through both the first refrigerant outlet B and the second refrigerant outlet C and is not supplied to both the cooling chamber evaporator and the freezing chamber evaporator. Therefore, from now on, the system operates in the idle mode.

For the operation in the freezing mode, it is needed to set the zero position (initialization position). When a motor control pulse signal (for example, “54” pulse) is inputted into the motor for the operation in the freezing mode, as shown in FIG. 9D, the refrigerant path groove 253 of the valve assembly 250 communicates with the second refrigerant outlet guide hole 263 of the base plate 260, but does not communicate with the first refrigerant outlet guide hole 262, so that the refrigerant is supplied to only the freezing chamber evaporator through the second refrigerant outlet C of the valve housing 280. From now on, the system operates in the freezing mode.

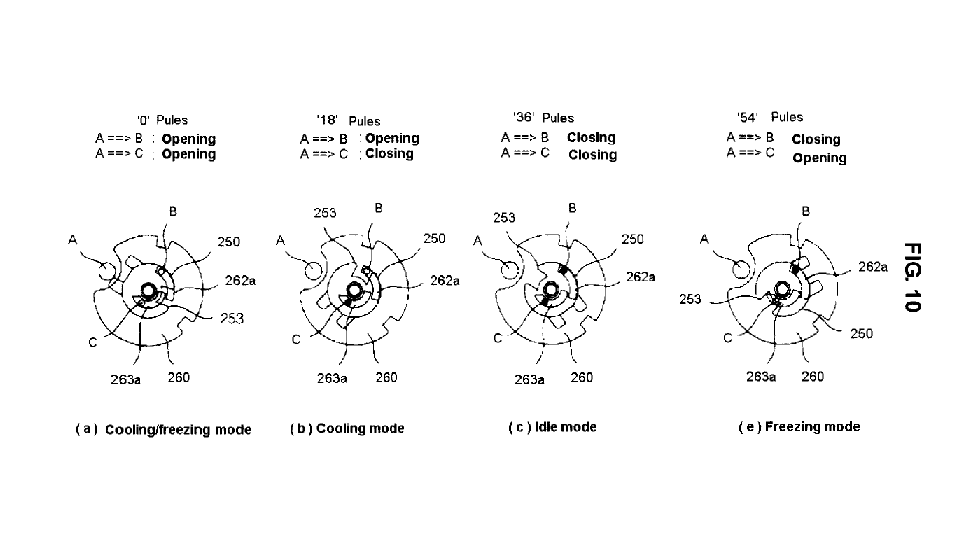

FIG. 10 is a view illustrating an operation mode of the electromotive refrigerant control valve according to another embodiment of the present invention. The system is switched to the operation mode in the same way as FIG. 9. As compared with FIG. 9, the first refrigerant outlet guide hole 262a and the second refrigerant outlet guide hole 263a of the base plate 260 are formed with different intervals with respect to the through hole 261.

The second embodiment of the present invention will be described with reference to the accompanying drawings. The same elements as the first embodiment of the present invention will be omitted and may be provided with the same reference numerals. The constructions of the stator assembly 230, the rotor casing 210 and the bracket 290 are same as the conventional art.

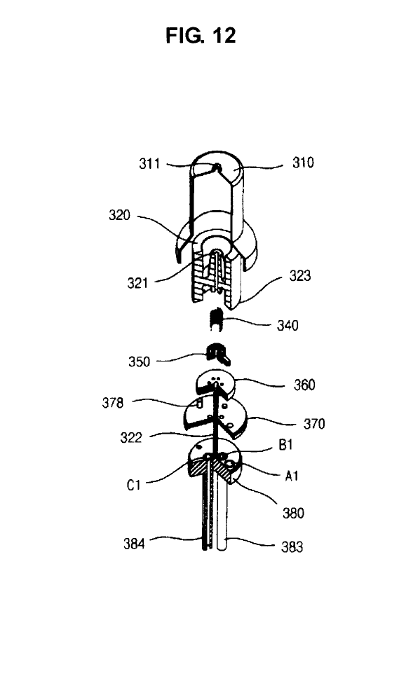

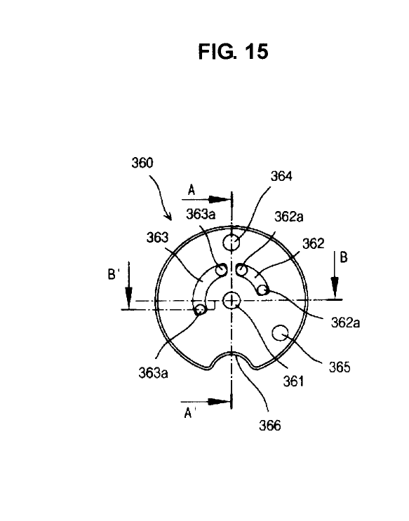

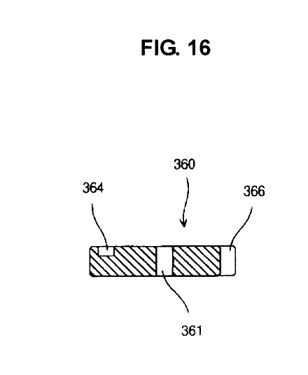

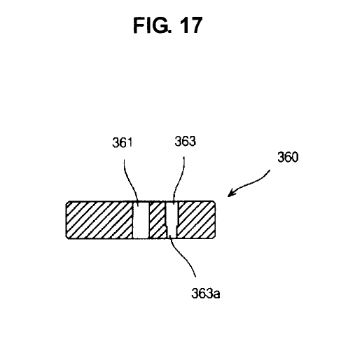

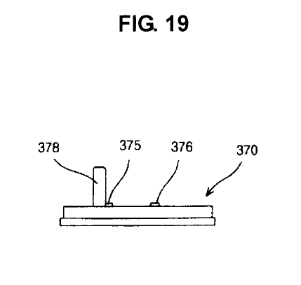

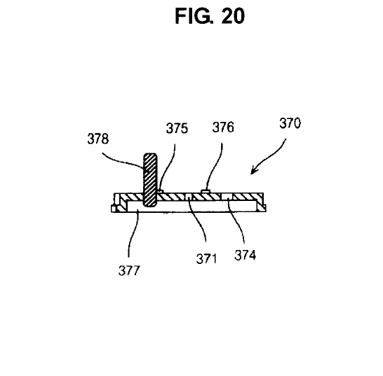

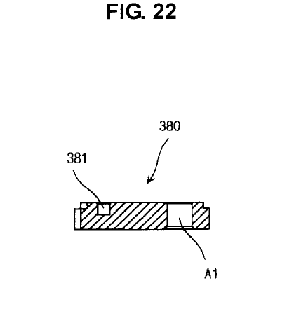

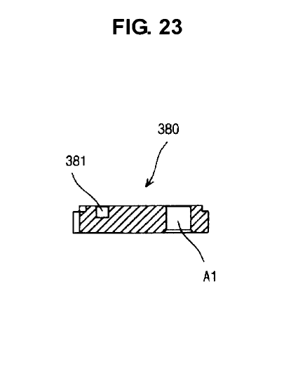

As shown in FIGS. 12 through 23, the rotor casing 310 is formed in a cap shape with a shaft rest part 311 being formed on the upper side of the same. The lower opening of the rotor casing 310 is covered by the under cover 370.

The magnet 320 is inserted into the interior of the rotor casing 310. A shaft 322 is fixedly inserted into a hub 321 formed at the center, with one end of the shaft 322 being inserted into the shaft rest part 311.

In the magnet 320, a protrusion 323 is formed at one side of the lower surface with respect to the center. A valve assembly fixture 324 (not shown in FIG. 12, but same as the valve assembly fixture 223 of FIG. 2) is formed at the protrusion 323, with a pair of the fixing protrusions 354 of the valve assembly 350 being inserted into the valve assembly fixture 324.

The compression spring 340 is inserted into the lower side of the hub 321 of the magnet 320 and generates an elastic force which allows the valve assembly 350 to move down in the axial direction of the shaft 322.

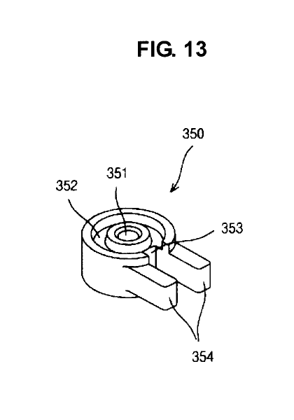

As shown in FIG. 13, the valve assembly 350 includes a through hole 351 formed at the center, with the shaft 322 being inserted into the through hole 351. A circular spring groove 352 is formed around the through hole 351 of the upper surface, with one end of the compression spring 340 being inserted into the circular spring groove 352. A refrigerant path groove 353 is formed at an outer surface of one side with respect to the through hole 351. A pair of fixing protrusions 354 are formed in the valve assembly 350 with respect to the refrigerant path groove 353 of the outer surface of one side and are inserted into the valve assembly fixture 324 of the magnet 320. The valve assembly 350 rotates together with the magnet 320 by the rotational force of the magnet 320 transferred through the valve assembly fixture 324 of the magnet 320 and the fixing protrusion 354 with a repulsive force of the compression spring 340 fixed at the upper surface. Since the valve assembly 350 has a plane shape at its lower and upper surfaces, the flatness and roughness of the same can be enhanced with the concurrent lapping and polishing processes with respect to the both surfaces. In addition, the base plate 360 may have flat lower and upper surfaces, and the flatness and roughness of the same could be enhanced based on the concurrent lapping and polishing processes. Since the valve assembly 350 is closely contacted with the base plate 360 for thereby preventing any leakage of the refrigerant. In particular, the valve assembly 350 is preferably made of a ceramic material which has excellent heat resisting property and durability for thereby preventing thermal transformation and extending life span.

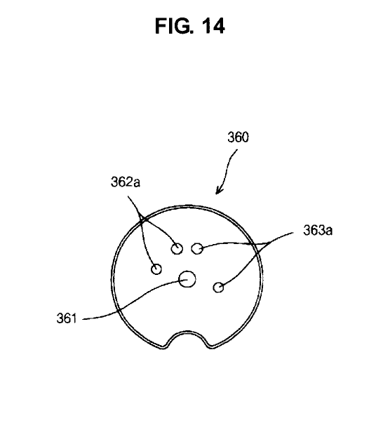

As shown in FIGS. 14 through 17, the base plate 360 includes a through hole 361 formed at the center of the same, with an end of the shaft 322, which is fixedly inserted into the valve assembly 350, being inserted into the through hole 361. A first refrigerant outlet guide groove 362 and a second refrigerant outlet guide groove 363 are formed at the lower surface of the same with certain intervals with respect to the through hole 361. Guide holes 362a and 363a are formed at the both ends of the first refrigerant outlet guide groove 362 and the second refrigerant outlet guide groove 363 and communicate with the upper surface, respectively. The base plate 360 includes a first cover fixing groove 364 and a second cover fixing groove 365 at certain intervals which are larger than the intervals of the first refrigerant outlet guide groove 362 and the second refrigerant outlet guide groove 363 with respect to the through hole 361 formed at the lower surface of the same. A refrigerant inlet path part 366 is formed at an outer surface of the base plate 360.

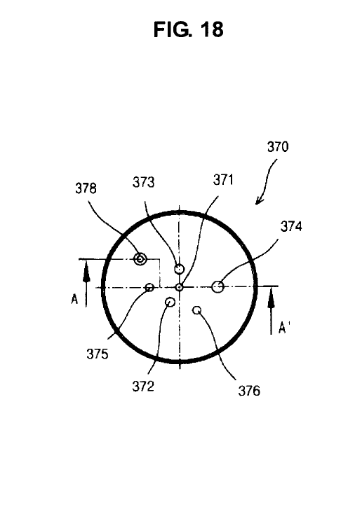

As shown in FIGS. 18 through 20, the under cover 370 covers the lower opening of the rotor casing 310 and forms a valve compartment in the interior of the rotor casing 310. The under cover 370 includes a through hole 371 formed at the center, with an end of the shaft 322, which passes through the base plate 360, being inserted into the through hole 371. The first refrigerant outlet hole 372, the second refrigerant outlet hole 373, and the refrigerant inlet guide hole 374, which communicate with the first refrigerant outlet guide groove 362 and the second refrigerant outlet guide groove 363 of the base plate 360 and the refrigerant inlet guide hole 374, are formed with certain intervals with respect to the through hole 371. The under cover 370 is provided with a first fixing protrusion 375 and a second fixing protrusion 376 which are inserted into the first cover fixing groove 364 and the second cover fixing groove 365 of the base plate 360, respectively. The under cover 370 is provided with a valve housing receiving part 377 formed at a lower surface of the same. A stopper shaft 378 passes through the upper and lower surfaces of the same, with the stopper shaft being caught by one side of each of the fixing protrusions 354 of the rotating valve assembly 350. Therefore, the base plate 360 does not rotate by the magnet 320.

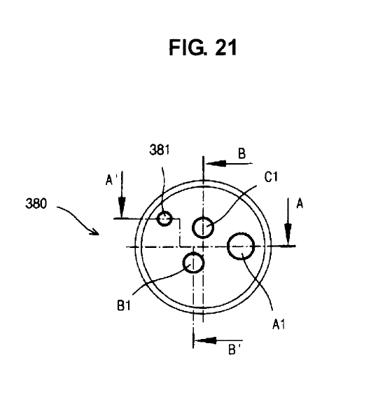

As shown in FIGS. 21 through 23, the valve housing 380 is fixedly inserted into the valve housing receiving part 376 of the under cover 370 and includes a stopper groove 381 formed at an upper surface in which an end of the shaft 322, passed through the under cover 370, contacts, with one end of the stopper shaft 378 protruded from the lower surface of the under cover 370 being inserted into the stopper groove 381. In the vase housing 380, there is provided a refrigerant inlet A1 which communicates with a refrigerant inlet path part 366 of the base plate 360 through the refrigerant inlet guide hole 374 of the under cover 370 and is connected with the condenser (not shown) by the input pipe 382. A first refrigerant outlet B1 communicates with the first refrigerant outlet hole 372 of the under cover 370 and is connected with the cooling chamber evaporator (not shown) by the output pipe 383. A second refrigerant outlet C1 communicates with the second refrigerant outlet hole 373 of the under cover 370 and is connected with the freezing chamber evaporator (not shown) by the output pipe 384.

The operation of the electromotive refrigerant control valve 300 according to a second embodiment of the present invention will be described with reference to the accompanying drawings.

First, as power is supplied to the motor which is formed of the stator assembly 230 and the magnet 220 and operates as an electromotive actuator, the magnet 220 operates in a normal or reverse direction by the magnetic force generated by the stator assembly 230 and allows the valve assembly 350 in a normal or reverse direction as a pair of the fixing protrusions 354 are inserted into the valve assembly fixture 324 (refer to reference numeral 223 of FIG. 2), with the valve assembly 350 being engaged with the magnet 320. The stopper shaft 378 of the under cover 370 is caught by the fixing protrusion 354 of one side of the valve assembly 350, so that the initialization setting, namely, zero setting is performed.

In the electromotive refrigerant control valve 300 according to the present invention, the rotational force of the magnet 320 is transferred to the valve assembly fixture 324 of the magnet 320 and the fixing protrusion 354 of the valve assembly 350 for thereby allowing the valve assembly 350 to rotate in a normal or reverse direction. With the above operation, in the refrigerant supply path, the refrigerant is supplied in the path of the refrigerant inlet A1 of the valve housing 380->the refrigerant inlet guide hole 374 of the under cover 370->the refrigerant inlet path part 366 of the base plate 360->the valve compartment formed in the interior of the rotor casing 310->the refrigerant path groove 353 of the valve assembly 350->the first refrigerant outlet guide groove 362 or the second refrigerant outlet guide groove 363 of the base plate 360->the guide hole 362a of both ends of the first refrigerant outlet guide groove 362 of the base plate 360 or the guide hole 363a of both ends of the second refrigerant outlet guide groove 363->the first refrigerant outlet hole 372 or the second refrigerant outlet hole 373 of the under cover 370->the first refrigerant outlet B1 or the second refrigerant outlet C1 of the valve housing 380->the output pipe 383 or the output pipe 384->the cooling chamber evaporator (not shown) or the freezing chamber evaporator (not shown).

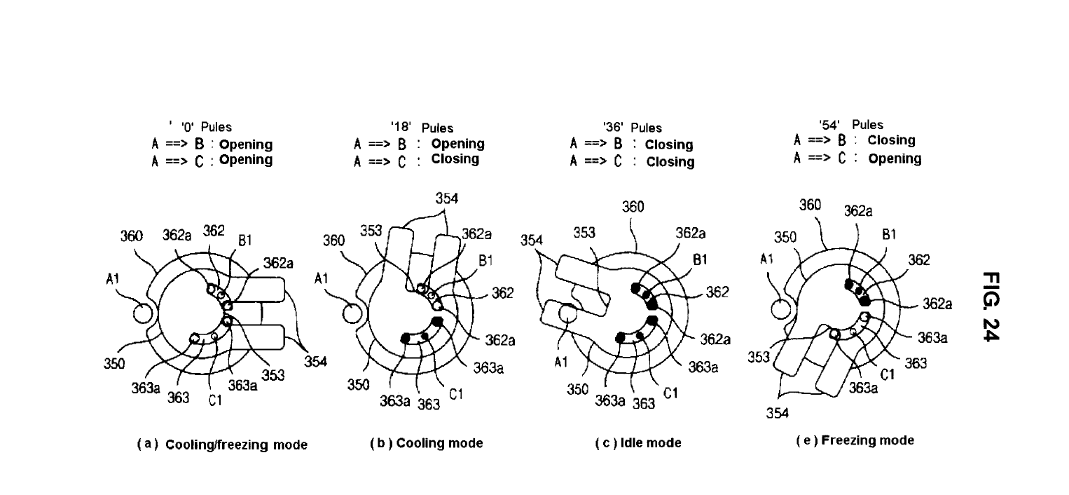

As shown in FIG. 24, for the operation in the cooling/freezing mode, the zero position (initialization position) is set. When a motor control pulse signal (for example, “0” pulse) is inputted into the motor, as shown in FIG. 24A, the refrigerant path groove 353 of the valve assembly 350 communicates with the guide hole 362a of the first refrigerant outlet guide groove 362 or the guide hole 363a of the second refrigerant outlet guide groove 363 through part of the first refrigerant outlet guide groove 362 of the base plate 360 and part of the second refrigerant outlet guide groove 363, so that the refrigerant is supplied to the cooling chamber evaporator and the freezing chamber evaporator through the first refrigerant outlet B1 and the second refrigerant outlet C1 of the valve housing 380. In this case, the system operates in the cooling/freezing mode.

For the operation in the cooling mode, it is needed to set the zero position (initialization position). When a motor control pulse signal (for example, “18” pulse) is inputted into the motor for the operation of the cooling mode, as shown in FIG. 24B, the refrigerant path groove 353 of the valve assembly 350 communicates with the guide hole 362a of the first refrigerant outlet guide groove 362 of the base plate 360 through part of the first refrigerant outlet guide groove 362 of the base plate 360, but does not communicate with the second refrigerant outlet guide groove 363. The refrigerant is supplied to only the cooling chamber evaporator through the first refrigerant outlet B1 of the valve housing 380. Therefore, the system operates in the cooling mode.

For the operation in the idle mode, it is needed to set the zero position (initialization position). When a motor control pulse signal (for example, “36” pulse) is inputted into the motor for the operation in the idle mode, as shown in FIG. 24C, the refrigerant path groove 353 of the valve assembly 350 does not communicate with both the first refrigerant outlet guide groove 362 and the second refrigerant outlet guide groove 363 of the base plate 360. The refrigerant is not supplied through the first refrigerant outlet B1 and the second refrigerant outlet C1 of the valve housing 380, so that it is not supplied to both the cooling chamber evaporator and the freezing chamber evaporator. From now on, the system operates in the idle mode.

For the operation in the freezing mode, it is needed to set the zero position (initialization position). When a motor control pulse signal (for example, “54” pulse) is inputted into the motor for the operation in the freezing mode, as shown in FIG. 24D, the refrigerant path groove 353 of the valve assembly 350 communicates with the guide hole 363a of the second refrigerant outlet guide groove 363 of the base plate 360 through part of the second refrigerant outlet guide groove 363 of the base plate 360, but does not communicate with the first refrigerant guide groove 362. Here, the refrigerant is supplied to only the freezing chamber evaporator through the second refrigerant outlet C1 of the valve housing 380. From now on, the system operates in the freezing mode.

### INDUSTRIAL APPLICABILITY

The electromotive refrigerant control valve according to the present invention is designed to operate in the four operation modes of the cooling/freezing mode, the cooling mode, the idle mode and the freezing mode with respect to the supply path of the refrigerant. In the present invention, it is possible to enhance the freezing/cooling efficiency as compared to the conventional electromotive refrigerant control valve in which the refrigerant supply path is switched in two operation modes of the cooling mode and the freezing mode. The energy consumption can significantly decrease by providing the idle mode.

In addition, the valve assembly and base plate each have flat surfaces, with the sealing being kept between the valve assembly and the base plate, so that more efficiency sealing is obtained based on the lapping and polishing processes. The valve assembly and base plate are made of a ceramic material so that the durability and heat resisting property are enhanced as compared to the conventional art in which the valve assembly and base plate are made of a resin material.

In one valve structure, the size and quantity of the guide holes 362a and 363a of the base plate can be adjusted, so that it is possible to diversify the control of flow amount.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An electromotive refrigerant control valve, comprising:
a cap shaped rotor casing in which a shaft rest part is formed at an upper surface of the same;
a magnet which is fixedly inserted into the interior of the rotor casing, with a shaft being fixedly inserted into a hub formed at a center portion of the magnet, with one end of the shaft being inserted into the shaft rest part, and with a valve assembly fixture being formed at one side of the lower inner surface with respect to the center portion, and with a protrusion being formed at one side of the lower surface of the magnet;
a stator assembly which is attached to an outer surface of the rotor casing and generates a magnetic force so as to rotate the magnet;
a compression spring which is inserted into the lower end of the hub of the magnet;
a valve assembly in which a through hole is formed at a center portion of the valve assembly, with the shaft being fixedly inserted into the through hole, and with a fixing part, which is inserted into the valve assembly fixture of the magnet, being formed at an outer surface of one side with respect to the through hole, and with a refrigerant path groove being formed at an outer surface of the other side, and with the valve assembly being designed to rotate together with the magnet by a rotational force of the magnet which is transferred through the valve assembly fixture of the magnet and the fixing part based on a repulsive force of the compression spring as the upper surface of the valve assembly contacts with the compression spring;
a base plate in which a through hole is formed at a center portion of the base plate, with an end portion of the shaft, fixedly inserted into the valve assembly, being inserted into the through hole, and with a first refrigerant outlet guide hole and a second refrigerant outlet guide hole being formed at regular intervals with respect to the through hole, and with a refrigerant inlet path part, a stopper groove and a cover fixing groove being formed at an outer surface of the base plate at regular intervals;
an under cover which covers a lower opening of the rotor casing, with a through hole being formed at a center portion of the under cover, with an end portion of the shaft, passed through the base plate, being inserted into the through hole, and with a first refrigerant outlet hole, a second refrigerant outlet hole and a refrigerant inlet guide hole, which communicate with the first refrigerant outlet hole, the second refrigerant outlet guide hole and the refrigerant inlet path part of the base plate, being formed at regular intervals with respect to the through hole, and with a stopper and a fixing protrusion being protruded from the upper surface of the under cover and being fixed with the stopper groove and the cover fixing groove of the base plate, respectively, and with a plurality of cover fixing protrusions being protruded from the lower surface of the under cover; and
a valve housing in which a plurality of fixing protrusion grooves engaged with the cover fixing protrusions of the under cover are formed on an upper surface contacting with an end portion of the shaft which passed through the under cover, and a refrigerant inlet communicates with the refrigerant inlet path part of the base plate, and a first refrigerant outlet and a second refrigerant outlet communicate with the first refrigerant outlet hole and the second refrigerant outlet hole of the under cover.

2. The valve of claim 1, wherein said first refrigerant outlet guide hole and said refrigerant outlet guide hole of the base plate are distanced with different intervals with respect to the through hole.

3. An electromotive refrigerant control valve, comprising:
a cap shaped rotor casing in which a shaft rest part is formed at an upper surface of the same;
a magnet which is fixedly inserted into the interior of the rotor casing, with a shaft being fixedly inserted into a hub formed at a center portion of the magnet, with an end portion of one side being inserted into the shaft rest part, and with a protrusion being protruded from one side of a lower surface with respect to the center portion, and with a valve assembly fixture being formed at the protrusion;
a stator assembly which is attached to an outer surface of the rotor casing and generates a magnetic force so as to rotate the magnet;
a compression spring which is inserted into a lower end of the hub of the magnet;
a valve assembly in which a through hole is formed at a center portion of the valve assembly, with the shaft being inserted into the through hole, and a spring groove is formed around the through hole of the upper surface, with one end of the compression spring being inserted into the spring groove, and a refrigerant path groove is formed at an outer surface of one side with respect to the through hole, and a pair of fixing protrusions inserted into the valve assembly fixtures of the magnet are formed with respect to the refrigerant path groove of the outer surface of the one side, with the valve assembly being rotated together with the magnet by a rotational force of the magnet transferred through the valve assembly fixture of the magnet and the fixing protrusion based on a repulsive force of the compression spring fixed at the upper surface of the same;
a base plate in which a through hole is formed at a center portion of the base plate, with an end portion of the shaft, inserted into the valve assembly, being inserted into the through hole, and a first refrigerant outlet guide groove and a second refrigerant outlet guide groove are formed at a lower surface of the base plate at regular intervals with respect to the through hole, and a guide hole communicating with the upper surface is formed at both ends of the first refrigerant outlet guide hole and the second refrigerant outlet guide groove, and a first cover fixing groove and a second cover fixing groove are formed with regular intervals which are larger than the intervals of the first refrigerant outlet guide groove and the second refrigerant outlet guide groove with respect to the through hole, and a refrigerant inlet path part is formed at an outer surface of the base plate and is straight with respect to the first cover fixing groove;
a under cover which covers a lower opening of the rotor casing, and in which a through hole being is formed at a center portion, with an end portion of the shaft, passed through the base plate, being inserted into the through hole, and a first refrigerant outlet hole and a second refrigerant outlet hole communicating with the first refrigerant outlet guide groove and the second refrigerant outlet guide groove of the base plate are formed with regular intervals with respect to the through hole, and a first fixing protrusion and a second fixing protrusion engaged with the first cover fixing groove and second cover fixing groove of the base plate are protruded from the upper surface of the under cover, and a valve housing receiving part is formed at a lower surface of the under cover, and a stopper shaft passes through the upper and lower surfaces and are caught by one side of each of the fixing protrusions of the rotating valve assembly; and
a valve housing which is fixedly inserted into the valve housing receiving part of the under cover, and in which a stopper groove is formed at an upper surface contacting with an end portion of the shaft which passed through the under cover, with one end of the stopper shaft, protruded from the lower surface of the under cover, being inserted into the stopper groove, and a refrigerant inlet communicates with the refrigerant inlet path part of the base plate, and a first refrigerant outlet and a second refrigerant outlet communicate with the first refrigerant outlet hole and the second refrigerant outlet hole of the under cover, respectively.
